(19) United States
(12) Patent Application Publication
(10) Pub. No.: US 2016/0055604 A1
(43) Pub. Date: Feb. 25, 2016

(54) Providing Learning Programs

(71) Applicant: SuccessFactors, South San Francisco, CA (US)

(72) Inventors: Joseph HERMAN, McLean, VA (US); Rachel JORDAN, Centreville, VA (US); Nikolaos ROUVAS, Leesburg, VA (US)

(21) Appl. No.: 14/720,341

(22) Filed: May 22, 2015

Related U.S. Application Data
(60) Provisional application No. 62/040,763, filed on Aug. 22, 2014.

(51) Int. Cl. G06Q 50/20; G09B 7/02; G09B 5/02

(52) U.S. Cl. CPC G06Q 50/2057; G09B 5/02; G09B 7/02

(57) ABSTRACT

Techniques are described for the creation and distribution of learning programs. Each learning program can include a collection of learning activities, some of which have been grouped into learning sections. The learning system can instantiate a restriction condition on a learning activity or learning section within the learning program. The restriction condition can affect when a learning activity or learning section can be executed. For example, the restriction condition can prevent a user from executing a second learning section within the learning program so long as a first learning section within the learning program is incomplete. The learning system can also credit the user for completing a learning activity even though the user has not consumed the learning activity when the learning activity is similar or the same as another learning activity which has been recently consumed.

### CROSS REFERENCE TO RELATED APPLICATIONS

The present disclosure is a continuation of and claims priority to U.S. Provisional Application No. 62/040,763 for “Providing Structured Learning Programs” filed Aug. 22, 2014, which is hereby incorporated herein by reference in its entirety for all purposes.

### BACKGROUND

The workforce of a business organization comprises employees from a variety of backgrounds and experiences. As a result, not all employees within the organization have the same knowledge base. Business organizations utilize learning programs to educate and train employees to ensure that all employees working within the organization have the same core foundation of knowledge. The education can include onboarding courses, academic courses, and training courses.

However, the generation and delivery of learning programs can be difficult. One technical problem is that the creation of learning programs can be time consuming and cumbersome, particularly if the learning materials are originating from various sources. Another technical program is that it is difficult to ensure a user goes through the learning program in a prescribed manner. For example, in a new-hire training program, it may be preferred that a user reviews corporate policies on paid-time-off (PTO) before those on medical or family leaves, as the former may be a prerequisite for understand the latter.

### SUMMARY

In one embodiment, a computer-implemented method presents, by a processor, a graphical user interface that includes a summary of a learning program assigned to a user account, the learning program containing a plurality of learning activities, wherein a first learning activity from the plurality of learning activities is required for completion of the learning program. The method then matches, by the processor, the first learning activity of the learning program to a second learning activity that was previously completed by the user account. The method then first updates, by the processor, a completion status of the first learning activity within the first learning program in response to the matching. The method then second updates. The method then second updates, by the processor, the summary of the learning program within the graphical user interface in response to the first updating of the completion status. assigns, by a processor, a first learning program to a user account, the first learning program containing a plurality of learning activities, wherein a first learning activity from the plurality of learning activities is required for completion of the first learning program. The method then matches, by the processor, the first learning activity of the first learning program to a second learning activity of a second learning program that was completed by the user within a predefined time frame, wherein the second learning program is also assigned to the user account. The method then updates, by the processor, a completion status of the first learning activity in response to the matching. In other embodiments, the second learning activity can be part of the same learning program as the first learning activity.

In one example, updating the completion status comprises marking, by the processor, the completion status of the learning activity to completed when the first learning activity is the same or substantially similar to the second learning activity.

In another example, the method further comprises determining, by the processor, that the learning program is associated with a discussion group and transmitting, by the processor, an invitation to join the discussion group to an email address associated with the user account.

In another example, the method further comprises receiving, by the processor, a request to begin a third learning activity from the plurality of learning activities, evaluating, by the processor, a restriction condition of the third learning activity, and restricting, by the processor, the execution of the third learning activity in response to the evaluation. One restriction condition can check whether a fourth learning activity has been completed. Another restriction condition can check a start time associated with the third learning activity.

In another example, the method further comprises determining, by the processor, that the first learning program has been completed and providing, by the processor, a certificate of completion to the user account in response to the determination.

In another embodiment, a non-transitory computer readable storage medium stores one or more programs comprising instructions for assigning a first learning program to a user account, the first learning program containing a plurality of learning activities, matching a first learning activity of the first learning program to a second learning activity of a second learning program that was completed by the user within a predefined time frame, wherein the second learning program is also assigned to the user account, and updating a completion status of the first learning activity in response to the matching. The first learning activity from the plurality of learning activities can be optional or required. In other embodiments, the second learning program and the first learning program can be one of the same.

In another embodiment, a computer implemented system comprises one or more computer processors and a non-transitory computer-readable storage medium. The non-transitory computer-readable storage medium comprises instructions, that when executed, control the one or more computer processors to be configured for assigning a first learning program to a user account, the first learning program containing a plurality of learning activities, wherein a first learning activity from the plurality of learning activities is required for completion of the first learning program, matching the first learning activity of the first learning program to a second learning activity of a second learning program that was completed by the user within a predefined time frame, wherein the second learning program is also assigned to the user account, and updating a completion status of the first learning activity in response to the matching.

The following detailed description and accompanying drawings provide a better understanding of the nature and advantages of the present disclosure.

### BRIEF DESCRIPTION OF THE DRAWINGS

FIG. 1 illustrates a system for generating and providing learning programs to users within an organization according to one embodiment;

FIG. 2 illustrates a user interface for creating a learning program according to one embodiment;

FIG. 3A illustrates another user interface for creating a learning program according to one embodiment;

FIG. 3B illustrates a dialog box of FIG. 3A according to one embodiment;

FIG. 4 illustrates a user interface for presenting a learning program according to one embodiment;

FIG. 5 illustrates a process for reducing repetition during the consumption of learning programs according to one embodiment; and

FIG. 6 illustrates an exemplary computer system according to one embodiment.

### DETAILED DESCRIPTION

In the following description, for purposes of explanation, numerous examples and specific details are set forth in order to provide a thorough understanding of the present disclosure. It will be evident, however, to one skilled in the art that the present disclosure as expressed in the claims may include some or all of the features in these examples alone or in combination with other features described below, and may further include modifications and equivalents of the features and concepts described herein.

Described herein are techniques for the creation and distribution of learning materials. The learning materials can be learning programs, training programs, and self-help programs. A learning system can create learning programs from available learning activities. Some of the available learning activities can be stored locally while others are stored remotely (for example, learning activities from a third party). Each learning program can include a collection of learning activities, some of which have been grouped into learning sections. In some examples, the learning sections or learning activities can have a specified order. For instance, a learning program can specify a predefined order in which to complete learning sections of the learning program. A particular learning section can specify a predefined order in which to present or complete the corresponding learning activities. In some embodiments, a restriction condition can be applied to a learning activity or learning section within the learning program. The restriction condition can affect when a learning activity or learning section can be executed. For example, the restriction condition can prevent a user from executing a second learning section within the learning program so long as a first learning section within the learning program is incomplete. As a result, the first learning section would have to be completed before the user may proceed to the second learning section.

During the execution of a learning program, the learning system can also monitor whether there are any completed learning activities or learning sections that are similar or a duplicate of a learning activity or learning section within the learning program. If a similarity is found, the learning system can mark the learning activity or learning section as being complete or partially complete, depending on the level of similarity between the learning activity or learning section and the completed learning activity or learning section. This allows the user to be credited for learning activities which he has already completed. In yet other embodiments, the learning system can also report the status or results of the learning program. For example, the learning system can provide a status update for a learning program when one is requested. As another example, the learning system can issue a certificate of completion to a user once the learning program has been completed.

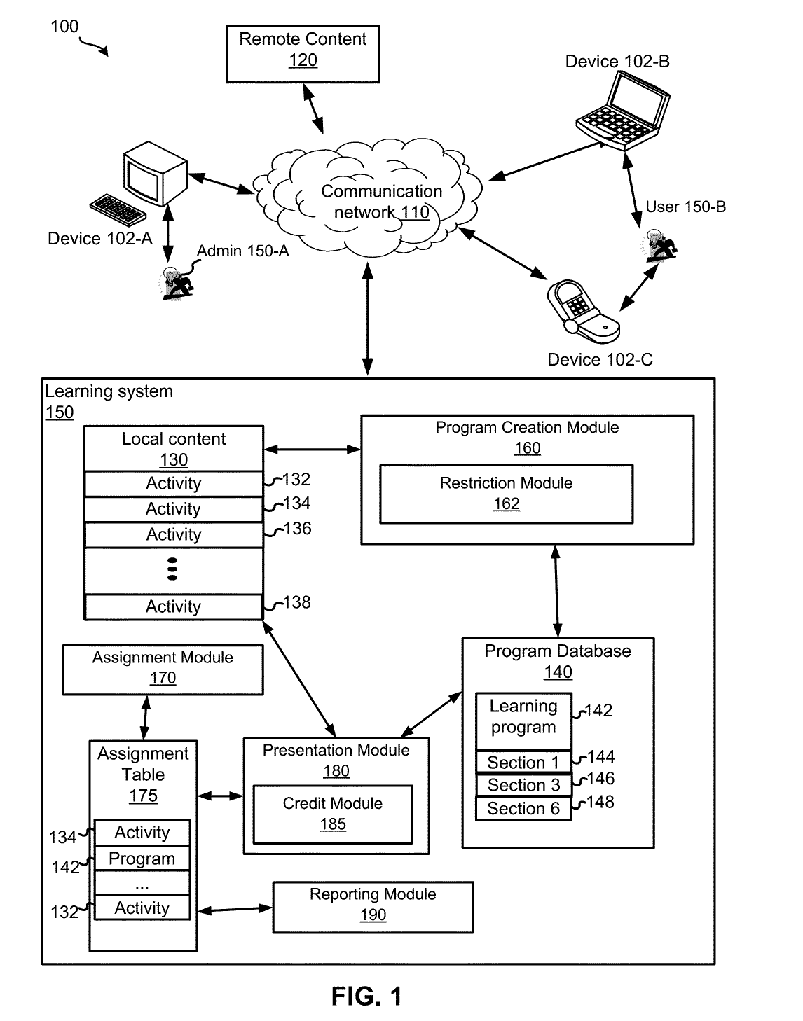

FIG. 1 illustrates a system for generating and providing learning programs to users within an organization according to one embodiment. System 100 includes learning system 150, device 102-A, device 102-B, and device 102-C. Device 102-A can be operated by administrator 150-A who is a person within the organization that is responsible for generating a learning program while device 102-B and device 102-C can be operated by user 150-B who is a user within the organization that consumes learning programs. Device 102-A can communicate with learning system 150 via communication network 110 to provide instructions for generating a learning program. Device 102-A can also communicate with learning system 150 via communication network 120 to provide instructions for assigning learning programs to one or more users within the organization. For example, learning system 150 can present a learning program to user 150-B. Depending on whether user 150-B is logged into device 102-B or device 102-C, learning system 150 can present the learning program on one of these two devices.

Learning system 150 includes program creation module 160, assignment module 170, presentation module 180, and reporting module 190. Program creation module 160 is configured to generate learning programs from available content. The available content includes local content 120, which includes activities 132, 134, 136, and 138. Program creation module 160 can also communicate with remote content 120 via communication network 110 to retrieve additional content that is available. Content creation module 160 can retrieve learning activities from local content 130 and remote content 120 to generate a learning program. The learning program can include learning activities. Some of the learning activities can be grouped into learning sections while other learning activities can be standalone. In one embodiment, program creation module 160 (through instructions received from admin 150-A) retrieves unique identifiers for learning activities and generates a learning program that contains the unique identifiers. The unique identifiers can be sequenced in a predefined order if the learning activities within the learning program are intended to be performed in a particular order. During execution of the learning program, presentation module 180 can present the learning activities by retrieving a learning activity that corresponds with a unique identifier in the learning program. Once retrieved, presentation module 180 can present the learning activity to a user who is assigned to the learning program. In another embodiment, program creation module 160 (through instructions received from admin 150-A) retrieves content learning activities content and generates a learning program that contains the content rather than unique identifiers that point to the content. During execution of the learning program, presentation module 180 can retrieve the learning program and present the contents stored within the learning program to user who is assigned to the learning program. Here, program creation module 160 can create learning program 142 which contains learning section 144, learning section 146, and learning section 148. Each learning section can include one or more learning activities from local content 130 or remote content 120. In some embodiments, the learning sections can group learning activities in a chronological or thematic fashion. Program creation module 160 can store learning program 142 within program database 140.

Program creation module 160 can include restriction module 162. Restriction module 162 is configured to set one or more restriction rules within the learning program. A restriction rule can be progress-based or schedule-based and can be associated with a learning activity within the learning program, learning section within the learning program, or the learning program itself. If the restriction rule is associated with a learning activity, consumption or presentation of the learning activity is restricted until the condition within the restriction rule is met. If the restriction rule is associated with a learning section, consumption or presentation of the learning activities within the learning section are restricted until the condition within the restriction rule is met. If the restriction rule is associated with the learning program, consumption or presentation of the learning activities within the learning program are restricted until the condition within the restriction rule is met. The restriction rules can be monitored during execution of the learning program to determine when the condition within the restriction rule is met.

A progress-based restriction rule restricts the consumption or presentation of a learning activity, learning section, or learning program until the completion of another learning activity, learning section, or learning program. This ensures that the learning material is consumed in a particular order. For example, a learning program can include learning section A, B, and C. A progress-based restriction rule can ensure that learning section A is completed (or consumed) prior to learning section C. Thus, consuming learning sections in the order of i) A, C, B or ii) A, B, C, or iii) B, A, C are all allowed according to the progress-based restriction rule since learning section A is completed prior to the beginning of learning section C. A schedule-based restriction rule restricts the consumption or presentation of a learning activity, learning section, or learning program until a start time. This ensures that the learning material is consumed at a specified pace. As a result, all users who are assigned to the learning program can consume the learning material at the specified pace. Advantages of schedule-based restriction rules include allowing users to consume the material as approximately the same pace which can maximize collaboration between users. Admin 150-A can transmit instructions to restriction module 162 to configure one or more restriction rules on the learning program.

Assignment module 170 is configured to assign learning activities and learning programs to a particular user. Learning activities and learning programs which are assigned to a user are entered into an assignment table that corresponds to the user. Here, assignment table 175 corresponds to user 150-B. Admin 150-A can transmit an instruction to learning system 150 to assign learning activity 134, learning program 142, and learning activity 132 to user 150-B. In response to the instruction, assignment module 170 can populate assignment table 175 (which corresponds to user 150-B) with learning activity 134, learning program 142, and learning activity 132. In some embodiments, each entry in assignment table 175 can include metadata to monitor the completion status of each item within assignment table 175. For example, the metadata can monitor whether learning activity 134 has been completed, or alternatively how much of learning activity 134 has been completed. Similarly, the metadata can monitor whether learning program 134 has been completed, or which learning sections (or learning activities) of learning program 134 have been completed. Advantages of storing the completion status of each item assigned to a user include the ability to monitor which users have consumed what learning material and the ability to generate report/completion certificates for a given user. In some embodiments, restriction rules can be applied to each learning program stored in program database 140

Presentation module 180 is configured to present the learning material to a user. When learning system 150 detects that user 150-B has logged into device 102-B (or alternatively device 102-C), presentation module 180 can transmit learning materials to the logged in device for user 150-B to consume. In one embodiment, presentation module 180 can query assignment table 175 for items which have been assigned to user 150-B and present a list of learning materials which the user may consume to the logged in device. When program module receives instructions from user 150-B requesting a particular learning item, presentation module 180 can communicate with local content 130, remote content 120, and program database 140 to retrieve the learning materials requested by user 150-B. The learning material can in turn be transmitted to the logged in device for user 150-B to consume.

In one embodiment, presentation module 180 can check whether a learning activity, learning section, or learning program has a restriction rule before transmitting the learning material to the logged in device for user 150-B to consume. For example, user 150-B may be consuming learning program 142 and submit a request to learning system 150 to present learning section 146. Presentation module 180 can query program database 140 to determine that learning section 146 is associated with a process-based restriction rule that requires section 144 to be consumed prior to the consumption of learning section 146. Presentation module 180 can communicate with assignment table 175 to determine whether learning section 144 has been completed (or consumed) by user 150-B. If learning section 144 has been consumed, then presentation module 180 can transmit one or more learning activities of learning section 146 to the logged in device. Alternatively if learning section 144 has not been consumed, then presentation module 180 can transmit a message to the logged in device to notify user 150-B that learning section 144 must be consumed prior to the consumption of learning section 146.

Often times, different learning programs can contain the same learning activity. For example, a learning activity such as review of office procedures can be included in the orientation learning program for each employee role within the organization. As a result, employees who have more than one role may be forced to complete the same or similar learning activity as part of two different learning programs. As another example, different academic courses can cover the same foundational knowledge before covering new learning material. As a result, some students may be forced to review the same learning material multiple times. To address this, presentation module 180 further includes credit module 185. Credit module 185 is configured to credit user 150-B for learning activities which are the same or similar to other learning activities which user 150-B has already completed.

<Add More Info>>

Reporting module 190 is configured to generate reports or certificate of completions for learning programs. In one embodiment, reporting module 190 can generate a report for a manager to check on the completion status of learning programs which have been assigned to the direct reports of the manager. The report can include links which allow the manager to contact a direct report to discuss a learning program. In another embodiment, reporting module 190 can generate a certificate of completion for a learning program. The certificate of completion can be generated and transmitted to a user when a user completes a learning program.

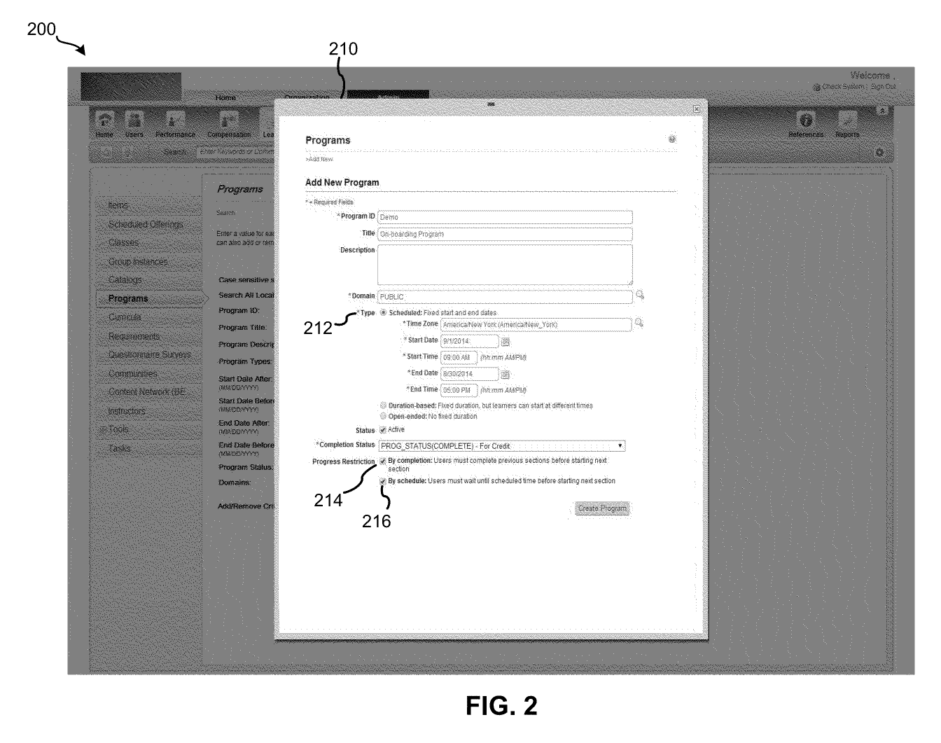

FIG. 2 illustrates a user interface for creating a learning program according to one embodiment. User interface 200 can be presented by learning system 150 to a device being operated by admin 150-A to configure a learning program. User interface 200 includes window 210 which includes a plurality of fields for configuring the learning program. Some of the fields are required (such as program type field 212) while other fields are optional (such as progress restriction fields 214 and 216). Program type field 212 is configured to allow an administrator to specify whether the learning program is a scheduled program, duration-based program, or an open-ended program. Depending on the program type, certain constraints can be applied to the learning program. For example, the learning activities which can be assigned to the learning program can vary. A scheduled program is a learning program which has a fixed start and end time. The scheduled program is available for a fixed duration that is confined by the fixed start and end time. In one embodiment, scheduled learning activities (e.g., learning activities with a fixed start and end time) can only be assigned to the scheduled learning program. As a result, learning system 150 can provide a warning to an administrator when the administrator attempts to add a scheduled learning activity to a non-scheduled program. A duration-based program is a learning program which has a fixed duration but has multiple start times or a flexible start time. For example, a duration-based program can a learning program which must be consumed by the user within a week. Thus, the duration-based program will be available to the user for the duration of a week once the user begins the learning program. An open-ended program is a learning program where learners can start at different times and learn at their own pace. An example of an open-ended program is an online learning program where the learning materials are pre-recorded.

Progress restriction field 214 can be set when the administrator wishes to restrict the progress of the learning program based on completion. If set, learning system 150 can automatically generate restriction rules that require learning activities within the learning program to be completed in sequential order. For example, an administrator can create a learning program that includes learning activity A, followed by learning activity B, followed by learning activity C. If progress restriction field 214 is set during the configuration of the learning program, learning system 150 or restriction module 162 can automatically generate a progress-based restriction rule on learning activity B requiring learning activity A to be completed before learning activity B can be consumed. Similarly, learning system 150 or restriction module 162 can automatically generate a progress-based restriction rule on learning activity C requiring learning activity B to be completed before learning activity C can be consumed. Progress restriction 216 field can be set when the administrator wishes to restrict the progress of the learning program based on schedule. As a result, the learning program can be limited to scheduled learning activities. If progress restriction field 216 is set, learning system 150 or program creation module 160 can check whether added learning activities are scheduled learning activities and trigger warnings for non-scheduled learning activities. In some examples, scheduled programs can have progress restriction field 216 set by default.

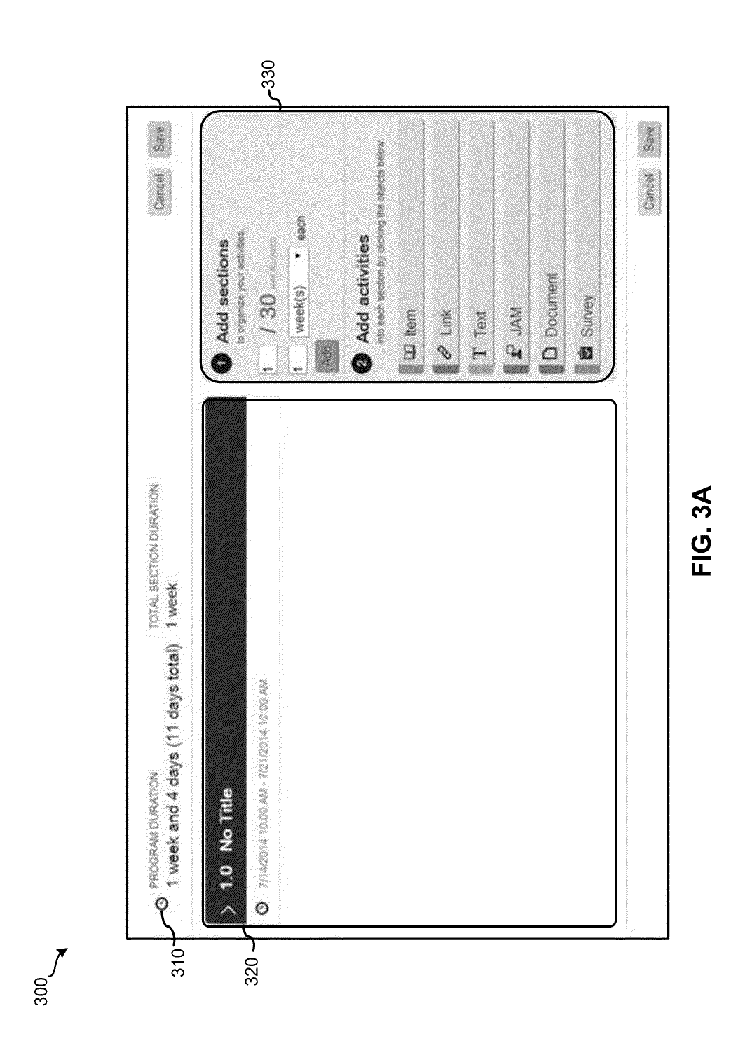

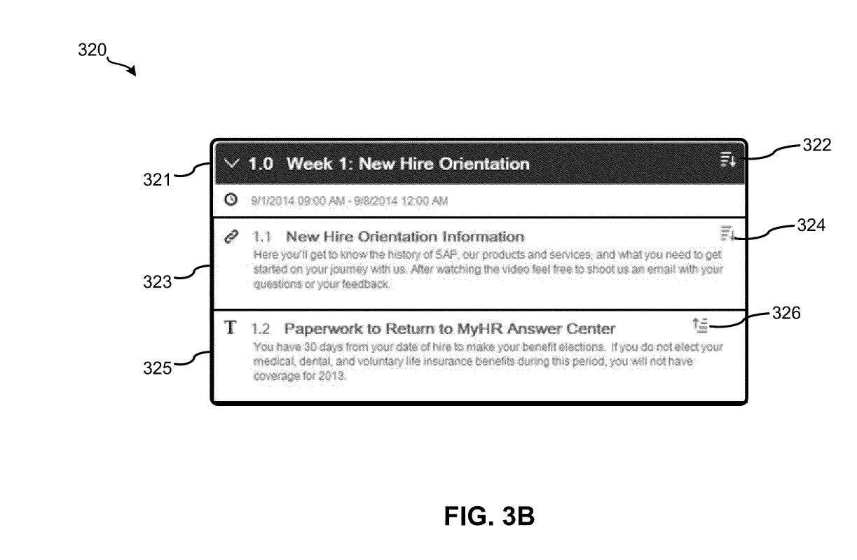

FIG. 3A illustrates another user interface for creating a learning program according to one embodiment. Here, the learning program is a scheduled program. User interface 300 can be presented to the administrator during the creation of the learning program. User interface 300 includes program duration field 310 which presents the duration of the learning program in its current state. As learning sections and learning activities are added to the learning program, program creation module 160 can automatically update program duration field 310 to present the duration of the learning program. User interface 310 further includes dialog box 320. Dialog box 320 can be configured to present the contents of the first learning section. As learning activities are added into the learning section, program creation module 160 can update dialog box 320 to display the learning activities which have been added. In one embodiment, user input can be received in user interface 300 to adjust the ordering of the learning activities within the learning section. For example, user input representative of dragging or reposition a learning activity within dialog box 320 can result in the reordering of the learning activities within the learning section. User interface 300 further includes control box 330. Control box 330 includes a plurality of actionable icons which allow an administrator to add new learning sections to the learning program and to add new learning activities to the learning program. Here, control box 330 includes actionable icons to allow an administrator to configure a new learning section by setting the duration of the learning section. Control box 330 further includes actionable icons to add in learning activities to a learning section. Learning activities include items, links, text, discussion groups (e.g., JAM), documents, and surveys. As described above, program creation module 160 can restrict the learning activities which can be added to the learning program in response to the program type. For example, program creation module 160 can restrict scheduled learning activities so that they can only be added to a scheduled program. For instance, program creation module 160 can skip displaying scheduled learning activities when the learning program is not a scheduled learning program.

FIG. 3B illustrates a dialog box of FIG. 3A according to one embodiment. As shown, dialog box 320 describes a learning section of a learning program. Dialog box 320 includes title 321 which provides a short description for the learning section. Title 321 includes repositioning icon 322 which, when selected, provides an instruction to program creation module 160 to reposition the learning section within the learning program (and as a result reposition dialog box 320 within user interface 300). Selecting link 322 can result in the learning section being repositioned within the learning program. For example, selecting link 322 can result in program creation module 160 repositioning the learning section that corresponds with dialog box 320 to a lower position within the learning program. For instance, learning section A (which corresponds with dialog box 320) is originally positioned above learning section B in the learning program. Upon selecting icon 322, program creation module 160 can reposition learning section B above learning section A in the learning program.

Dialog box 320 also includes learning activity 323. Learning activity 323 includes a title and a short description that describes learning activity 323. Learning activity 323 further includes a link icon signifying that the learning activity provides a link to another web page where the new hire orientation information can be reviewed. Similar to title 321, learning activity 323 further includes icon 324 which, when selected, can reposition learning activity 323 to another position within the learning section. In one example, selecting icon 324 can move learning activity 323 one position down in the learning section. In other examples, learning activity 323 can include multiple icons to move the learning activity up or down within the learning section. Dialog box 3209 further includes learning activity 325. Similar to learning activity 323, learning activity 325 also includes a title, a short description, and icon 326 to reposition the learning activity within the learning section.

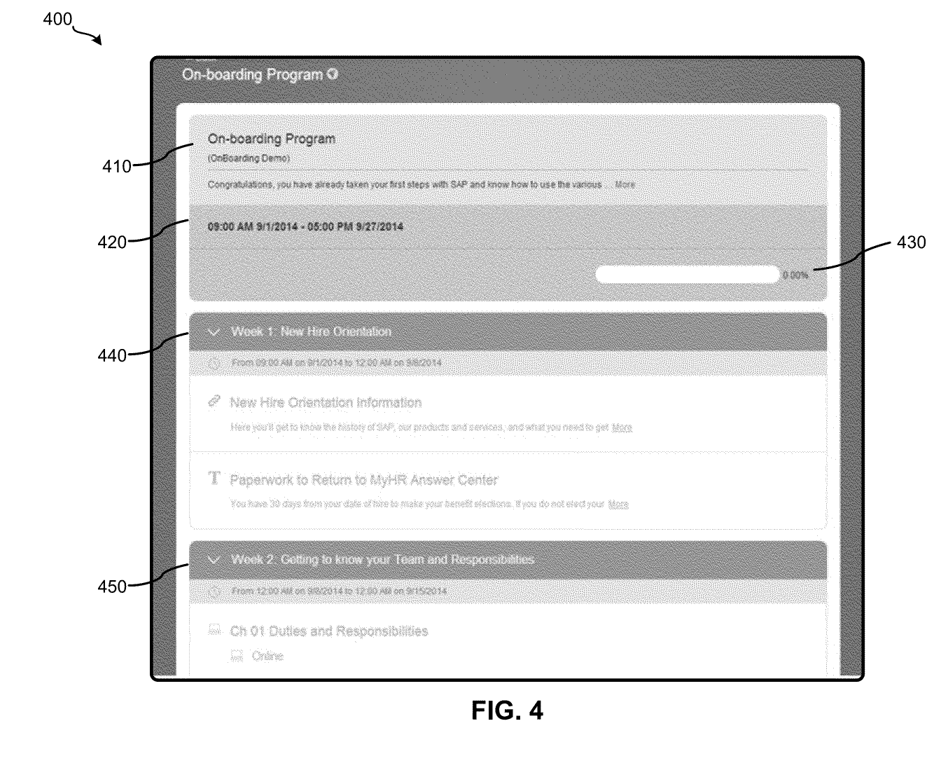

FIG. 4 illustrates a user interface for presenting a learning program according to one embodiment. Presentation module 180 can transmit user interface 400 to a device operated by the user whom the learning program is assigned to. The device can in turn present user interface 400 on a display of the device for consumption by the user. User interface 400 includes title 410 which provides the title of the learning program. Under title 410 is duration 420 which provides the information describing the duration of the program. Under duration 420 is completion bar 430. Completion bar 430 is configured to report on the percentage of completion of the learning program. As the user completes learning activities within the learning program, presentation module 180 can update completion bar 430 to represent the portion of the learning program that has been completed. In one embodiment, presentation module 180 can query assignment table 175 and analyze the completion status of learning activities within learning program 142. Based on the analysis, presentation module 180 can generate completion bar 430. In some embodiments, presentation module 180 can incrementally update completion bar 430 as the user consumes or completes learning activities within the learning program. User interface 400 further includes learning section 440 and learning section 450. Each learning section within the learning program can list the learning activities within the learning section. Together, the learning sections can be presented to the user as a part of a learning agenda. Presentation module can subsequently transition to a different user interface in response to receiving user input representative of selecting a learning activity (or learning section) within user interface 400.

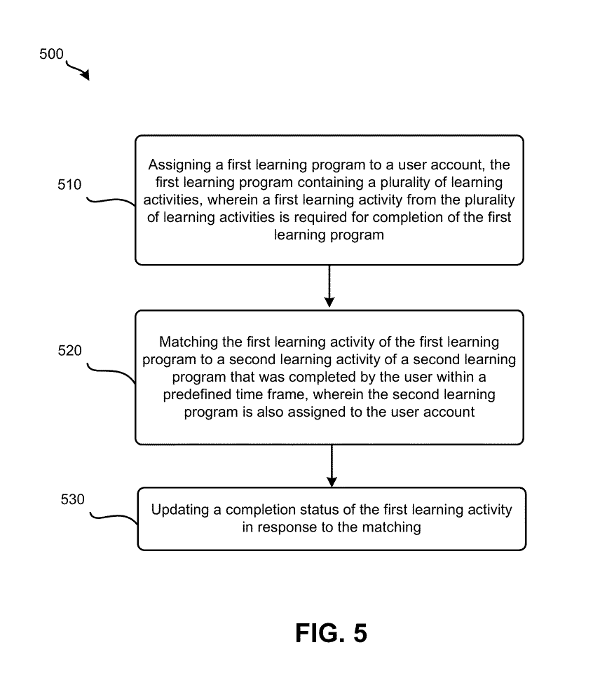

FIG. 5 illustrates a process for reducing repetition during the consumption of learning programs according to one embodiment. Process 500 can be stored in computer readable code and executed by a processor. For example, process 500 can be part of the computer readable code that is executed by learning system 150 of FIG. 1. Process 500 can begin by assigning a first learning program to a user account at 510. The first learning program can contain a plurality of learning activities where a first learning activity from the plurality of learning activities is required for completion of the first learning program. In one embodiment, assignment module 170 of learning system 150 can add an instance of the first learning program into assignment table 175 when assigning the first learning program to the user. In one embodiment, process 500 can evaluate the assigned learning program to determine whether a discussion group has been assigned to the learning program. If a discussion group has been assigned to the learning program, process 500 can automatically generate an email invitation to join the discussion group to an email address associated with the user.

After the first learning program has been assigned, process 500 can continue by matching the first learning activity of the first learning program to a second learning activity of a second learning program that was completed by the user at 520. As described, the first learning activity is part of the first learning program that is active while the second learning activity is part of the second learning program that has been completed. However it is to be understood that in other embodiments, the first learning activity and the second learning activity can be belong to the same learning program. Both the first learning activity and the second learning activity can be related to one another. For example, the first learning activity can be related to onboarding and the second learning activity can also related to onboarding. The user has completed the second learning program and is in the process of completing the first learning program. During this time, learning system 150 can check learning programs when they are assigned to determine whether the assigned learning program includes any learning activities which are similar to a learning activity which was recently completed by the user. Learning activities within the assigned learning program which are similar to a completed learning activity can be automatically marked as completed without being consumed by the user since the user has already consumed similar learning material in another learning program. This can be advantageous since it allows the user to avoid repetitious learning activities. For example, it is undesirable for the user to have to consume an introductory course on how to user a peripheral device multiple times since the introductory course is a section in two different learning programs.

In one embodiment, process 500 can identify the first learning activity by examining the first learning program to identify a learning activity within the first learning program which is a required learning activity. Required learning activities within the first learning program can include a flag to signify that the learning activity is required. Once the required learning activity has been identified, process 500 can search the history of the user to identify learning activities which have been completed recently. For example, learning activities which have been completed within a predefined period of time such as a month can be selected and examined to determine whether the required learning activity matches any of the recently completed learning activities. Matching can be determined using various techniques. In one example, each learning activity within local content 130 and remote content 120 can include a unique identifier. During matching, process 500 can match the unique identifiers to determine whether the required learning activity is the same as a completed learning activity. In another example, process 500 can compare the learning activities to determine a level of similarity. For instance, program 500 can compare links, images, or text within the learning activities to calculate a similarity score. If the similarity score is above a predefined threshold (such as 90%), program 500 can consider the two learning activities to be the same or similar. If the similarity store is within another predefined threshold (such as 70-90%), program 500 can consider the two learning activities to be partially similar.

Process 500 can continue by updating a completion status of the first learning activity in response to the matching at 530. Process 500 can update the completion status to completed when the first learning activity (e.g., assigned learning activity) is the same or similar to the second learning activity (e.g., recently completed learning activity). In essence, the user can be credited for the completion of the first learning activity without having to actually consume the learning activity with the rationale being that the learning activity is similar to another recently completed learning activity. Alternatively, process 500 can update the completion status to partially completed when the first learning activity is partially similar to the second learning activity. Updating the completion status to partially completed can result in process 500 providing a partial credit to the user for the first learning activity. A partial credit can be analogous to the user having already completed a portion of the learning activity. For example, if the first learning activity and the second learning activity both include a video and the user has already watched the video while consuming the second learning activity, process 500 can update the video from being required to being optional.

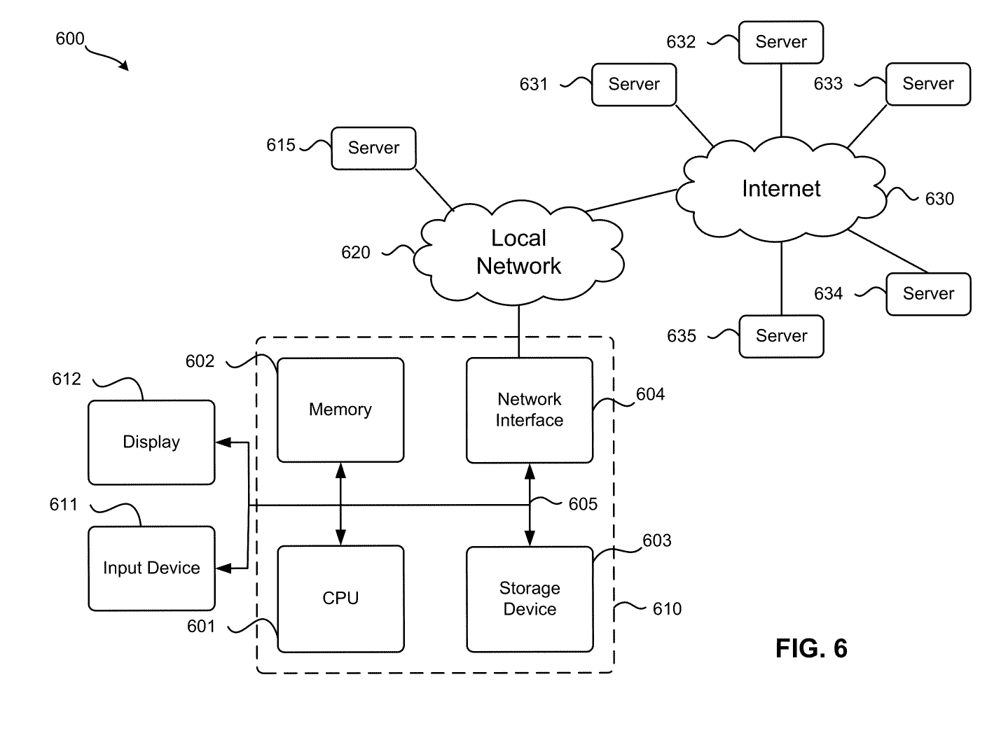

An exemplary computer system 600 is illustrated in FIG. 6. Computer system 610 includes a bus 605 or other communication mechanism for communicating information, and a processor 601 coupled with bus 605 for processing information. Computer system 610 also includes memory 602 coupled to bus 605 for storing information and instructions to be executed by processor 601, including information and instructions for performing the techniques described above, for example. This memory may also be used for storing variables or other intermediate information during execution of instructions to be executed by processor 601. Possible implementations of this memory may be, but are not limited to, random access memory (RAM), read only memory (ROM), or both. A storage device 603 is also provided for storing information and instructions. Common forms of storage devices include, for example, a hard drive, a magnetic disk, an optical disk, a CD-ROM, a DVD, a flash memory, a USB memory card, or any other medium from which a computer can read. Storage device 603 may include source code, binary code, or software files for performing the techniques above, for example. Storage device and memory are both examples of computer readable mediums.

Computer system 610 may be coupled via bus 605 to a display 612, such as a cathode ray tube (CRT) or liquid crystal display (LCD), for displaying information to a computer user. An input device 611 such as a keyboard and/or mouse is coupled to bus 605 for communicating information and command selections from the user to processor 601. The combination of these components allows the user to communicate with the system. In some systems, bus 605 may be divided into multiple specialized buses.

Computer system 610 also includes a network interface 604 coupled with bus 605. Network interface 604 may provide two-way data communication between computer system 610 and the local network 620. The network interface 604 may be a digital subscriber line (DSL) or a modem to provide data communication connection over a telephone line, for example. Another example of the network interface is a local area network (LAN) card to provide a data communication connection to a compatible LAN. Wireless links are another example. In any such implementation, network interface 604 sends and receives electrical, electromagnetic, or optical signals that carry digital data streams representing various types of information.

Computer system 610 can send and receive information, including messages or other interface actions, through the network interface 604 across a local network 620, an Intranet, or the Internet 630. For a local network, computer system 610 may communicate with a plurality of other computer machines, such as server 615. Accordingly, computer system 610 and server computer systems represented by server 615 may form a cloud computing network, which may be programmed with processes described herein. In the Internet example, software components or services may reside on multiple different computer systems 610 or servers 631-635 across the network. The processes described above may be implemented on one or more servers, for example. A server 631 may transmit actions or messages from one component, through Internet 630, local network 620, and network interface 604 to a component on computer system 610. The software components and processes described above may be implemented on any computer system and send and/or receive information across a network, for example.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

What is claimed is:

1. A computer-implemented method, comprising:
presenting, by a processor, a graphical user interface that includes a summary of a learning program assigned to a user account, the learning program containing a plurality of learning activities, wherein a first learning activity from the plurality of learning activities is required for completion of the learning program;
matching, by the processor, the first learning activity of the learning program to a second learning activity that was previously completed by the user account;
first updating, by the processor, a completion status of the first learning activity within the first learning program in response to the matching; and
second updating, by the processor, the summary of the learning program within the graphical user interface in response to the first updating of the completion status.

2. The computer-implemented method of claim 1, wherein first updating the completion status comprises marking, by the processor, the completion status of the learning activity to completed when the first learning activity is the same or substantially similar to the second learning activity.

3. The computer-implemented method of claim 1, the method further comprising:
determining, by the processor, that the learning program is associated with a discussion group; and
transmitting, by the processor, an invitation to join the discussion group to an email address associated with the user account.

4. The computer-implemented method of claim 1, the method further comprising:
receiving, by the processor, a request to begin a third learning activity from the plurality of learning activities;
evaluating, by the processor, a restriction condition of the third learning activity; and
restricting, by the processor, the execution of the third learning activity in response to the evaluation.

5. The computer-implemented method of claim 4, wherein the restriction condition checks whether a fourth learning activity has been completed.

6. The computer-implemented method of claim 4, wherein the restriction condition checks a start time associated with the third learning activity.

7. The computer-implemented method of claim 1, the method further comprising:
determining, by the processor, that the learning program has been completed; and
providing, by the processor, a certificate of completion to the user account in response to the determination.

8. A non-transitory computer readable storage medium storing one or more programs, the one or more programs comprising instructions for:
presenting a graphical user interface that includes a summary of a learning program assigned to a user account, the learning program containing a plurality of learning activities, wherein a first learning activity from the plurality of learning activities is required for completion of the learning program;
matching the first learning activity of the learning program to a second learning activity that was previously completed by the user account;
first updating a completion status of the first learning activity within the first learning program in response to the matching; and
second updating the summary of the learning program within the graphical user interface in response to the first updating of the completion status.

9. The non-transitory computer readable storage medium of claim 8, wherein first updating the completion status comprises marking the completion status of the learning activity to completed when the first learning activity is the same or substantially similar to the second learning activity.

10. The non-transitory computer readable storage medium of claim 8, the method further comprising:
determining that the learning program is associated with a discussion group; and
transmitting an invitation to join the discussion group to an email address associated with the user account.

11. The non-transitory computer readable storage medium of claim 8, the method further comprising:
receiving a request to begin a third learning activity from the plurality of learning activities;
evaluating a restriction condition of the third learning activity; and
restricting the execution of the third learning activity in response to the evaluation.

12. The non-transitory computer readable storage medium of claim 11, wherein the restriction condition checks whether a fourth learning activity has been completed.

13. The non-transitory computer readable storage medium of claim 11, wherein the restriction condition checks a start time associated with the third learning activity.

14. The non-transitory computer readable storage medium of claim 8, the method further comprising:
determining that the learning program has been completed; and
providing a certificate of completion to the user account in response to the determination.

15. A computer implemented system, comprising:
one or more computer processors; and
a non-transitory computer-readable storage medium comprising instructions, that when executed, control the one or more computer processors to be configured for:
presenting a graphical user interface that includes a summary of a learning program assigned to a user account, the learning program containing a plurality of learning activities, wherein a first learning activity from the plurality of learning activities is required for completion of the learning program;
matching the first learning activity of the learning program to a second learning activity that was previously completed by the user account;
first updating a completion status of the first learning activity within the first learning program in response to the matching; and
second updating the summary of the learning program within the graphical user interface in response to the first updating of the completion status.

16. The computer implemented system of claim 15, wherein first updating the completion status comprises marking the completion status of the learning activity to completed when the first learning activity is the same or substantially similar to the second learning activity.

17. The computer implemented system of claim 15, the method further comprising:
determining that the learning program is associated with a discussion group; and
transmitting an invitation to join the discussion group to an email address associated with the user account.

18. The computer implemented system of claim 15, the method further comprising:
receiving a request to begin a third learning activity from the plurality of learning activities;
evaluating a restriction condition of the third learning activity; and
restricting the execution of the third learning activity in response to the evaluation.

19. The computer implemented system of claim 18, wherein the restriction condition checks whether a fourth learning activity has been completed.

20. The computer implemented system of claim 18, wherein the restriction condition checks a start time associated with the third learning activity.
